(19) United States
(12) Patent Application Publication
(10) Pub. No.: US 2026/0093528 A1
(43) Pub. Date: Apr. 2, 2026

(54) ARTIFICIAL-INTELLIGENCE ENABLED SYSTEMS AND METHODS FOR TASK ESTIMATION

(71) Applicant: John Graham Cvinar, West Chester, PA (US)

(72) Inventor: John Graham Cvinar, West Chester, PA (US)

(21) Appl. No.: 19/337,566

(22) Filed: Sep. 23, 2025

Related U.S. Application Data
(60) Provisional application No. 63/700,003, filed on Sep. 27, 2024.

(51) Int. Cl. G06F 9/48; G06N 3/045

(52) U.S. Cl. CPC G06F 9/4881; G06N 3/045

(57) ABSTRACT

Computer system and method schedule tasks by predicting task completion of one or more candidate resources. Various information sources are used for prediction and scheduling tasks, including task completion history, years of experience, and schedule availability of the one or more candidate resources.

### RELATED APPLICATION(S)

This application claims the benefit of U.S. Provisional Application No. 63/700,003, filed on Sep. 27, 2024. The entire teachings of the above application(s) are incorporated herein by reference.

### BACKGROUND

Scheduling tasks for team members ensures clear priorities and efficient time management, helping the team stay organized and focused. Predicting task completion allows a team lead or project manager to anticipate delays and adjust plans, ensuring the project remains on schedule. Together, these practices enhance collaboration, accountability, and overall productivity among team members.

### SUMMARY

If task completion prediction is not performed, critical tasks may be overlooked or delayed, leading to missed deadlines and project failures. Resource allocation could become inefficient, as managers may not prioritize tasks that are at risk of non-completion. Additionally, the inability to identify and address potential bottlenecks early can result in increased costs and reduced productivity.

Computer systems and methods that schedule tasks and predict task completion are a powerful approach to managing task deadlines and ensuring that projects remain on track (on schedule). Information relevant for task completion prediction include task attributes (e.g., task type, task complexity, resources available, etc.) and human resource attributes (e.g., personnel or team member's history of completing similar tasks, experience level, current workload, etc.).

Applicants describe herein a system and method to schedule tasks by predicting task completion of a resource (e.g., a team member). Embodiments provide a computer-based tool that automatically generates a prediction of task completion of one or more tasks by a resource, said automatic prediction generation including employing an artificial intelligence model operating on: (i) the one or more tasks, and (ii) profile of the resource.

In an embodiment disclosed herein is a computer-based system for scheduling tasks, comprising: (1) an interface module executable by a processor and configured to: (a) interactively receive from a user a selection of one or more tasks; (b) interactively receive from the user a selection of a resource from one or more candidate resources to perform the selected one or more tasks; and (c) responsively render to the user an indication of a prediction of task completion of the selected one or more tasks by the selected resource, (2) a scheduler module communicatively coupled to the interface module and executable by the processor, the scheduler module configured to generate, using artificial intelligence, the prediction of task completion by the selected resource based on the selected one or more tasks and profile of the selected resource.

In another embodiment disclosed herein is a computer-based method of scheduling tasks, comprising: receiving, in computer memory, (i) a user-interactive selection of one or more tasks, and (ii) a user-interactive selection of a resource from one or more candidate resources, each user-interactive selection being received by a digital processor from a user through an interface, the digital processor coupled to the computer memory; responsively generating a prediction of completion of the selected one or more tasks by the selected resource, said generating employing an artificial intelligence model operating on: (i) the selected one or more tasks, and (ii) profile of the selected resource; and outputting an indication of the generated prediction through the interface to the user.

In yet another embodiment disclosed herein is a computer program product for scheduling tasks, the computer program product comprising: a non-transitory computer-readable storage medium providing at least a portion of computer code instructions that, when executed by a processor, cause an apparatus associated with the processor to: user-interactively receive a selection of one or more tasks, resulting in selected one or more tasks; user-interactively receive a selection of one resource from among one or more candidate resources, resulting in a selected resource; automatically generate a prediction of task completion of the selected one or more tasks by the selected resource, said automatically generate including employing an artificial intelligence model operating on: (i) the selected one or more tasks, and (ii) profile of the selected resource; and render as output of the apparatus an indication of the prediction of task completion by the selected resource.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic view of the system architecture in one embodiment of the present invention.

FIG. 2 is a block diagram of an example system integrated with a web portal server, network, and database, according to an embodiment.

FIG. 3 is a flowchart of a method of scheduling tasks, according to an embodiment.

FIG. 4 is a schematic view of a computer network environment in which embodiments may be deployed.

FIG. 5 is a block diagram of a computer node in the computer network of FIG. 4.

FIG. 6 is a view of the user interface in which the task history of the selected member is being processed for predicting the duration of task completion, in one embodiment.

FIG. 7 is a view of the user interface in which the prediction results of the duration of task completion for a selected member is displayed, and the lead has the option of applying or dismissing the results, in one embodiment.

FIG. 8 is a condensed schema of data in a database that contains information for system 100, in one embodiment.

FIG. 9 is a flowchart for predicting task completion for a selected user, in one embodiment.

### DETAILED DESCRIPTION

A description of example embodiments follows.

Unless otherwise defined, all technical and scientific terms used herein have the same meaning as commonly understood by one of ordinary skill in the art. Those skilled in the art to which the present disclosure pertains may make modifications resulting in other embodiments or aspects employing principles of the present invention without departing from its spirit or characteristics, particularly upon considering the foregoing and following teachings. In case of conflict, the present specification, including definitions, will control. In addition, the embodiments, aspects, and examples are illustrative only and not intended to be limiting. Other features and advantages of the present disclosure will be apparent from the following detailed description, and from the claims. While the present disclosure includes references to particular embodiments and aspects, modifications of system architecture, configurations, and the like apparent to those skilled in the art still fall within the scope as claimed.

As used herein, “model” includes, and is not limited to, classification models, time series models, neural network models, linear regression models, logistic regression models, decision trees, support vector machines, Naive Bayes networks, k-nearest neighbor (KNN) models, k-means models, random forest models, association rule learning models, inductive logic programming models, reinforcement learning models, feature learning models, similarity learning models, sparse dictionary learning models, genetic algorithm models, rule-based machine learning models, learning classifier system models, or any combination thereof.

To determine prediction quality, the performance of the prediction model is evaluated in terms of various metrics such as accuracy, recall, precision, mean square error, etc., depending on the type of model. Prediction quality is also evaluated based on other factors including the amount of lead time before asset failure. For example, multiple models using the same historical sensor data may be generated but each with different lengths of time prior to predicted failure in order to identify at least one model with an acceptable accuracy at an acceptable prediction time before asset failure is expected to occur. If the evaluation of the model using a selected data set indicates that the model's predictions are inadequate with respect to quality, a decision to re-train the model may be made.

As used herein, “database” includes, and is not limited to, one or more databases configured as any suitable data store structure, such as a network, relational, hierarchical, multi-dimensional or object database. The database (or more generally data store) may be located within main memory (e.g., in the RAM) and/or within non-volatile memory (e.g., on a persistent hard disk). Database includes one or more databases deployed in an on-premise environment, cloud environment, and/or a combination thereof.

The present invention addresses the need for improved systems and methods for scheduling tasks, such as using an artificial intelligence-based module trained on historical data (e.g., task history of a member) to make predictions of task completion (e.g., duration for a member to complete a given task, estimated accuracy of task completion, etc.) and/or select a candidate resource (e.g., member) best suited for completing a task. For non-limiting example, a member who completes a given task in the shortest duration compared to other members may not necessarily be best suited for completing the task if other factors, such as schedule availability (e.g., the number of tasks a member is currently assigned to, scheduled time off, scheduled shifts including evenings, weekends, and holidays, etc.), are considered.

An embodiment of the present invention implements guided workflows for scheduling tasks (e.g., the total amount of time a selected member will take to finish a task). A user (e.g., team lead, or project manager) may first select a task (e.g., via a user interface, the user opens a card that the user previously created to represent a certain task). The user may then select a resource (e.g., a team member) to take on the task. The scheduler module then attempts to pull up, access, or otherwise obtain relevant data and make a prediction of task completion. In some embodiments, task completion includes time duration for the resource to complete the selected one or more tasks.

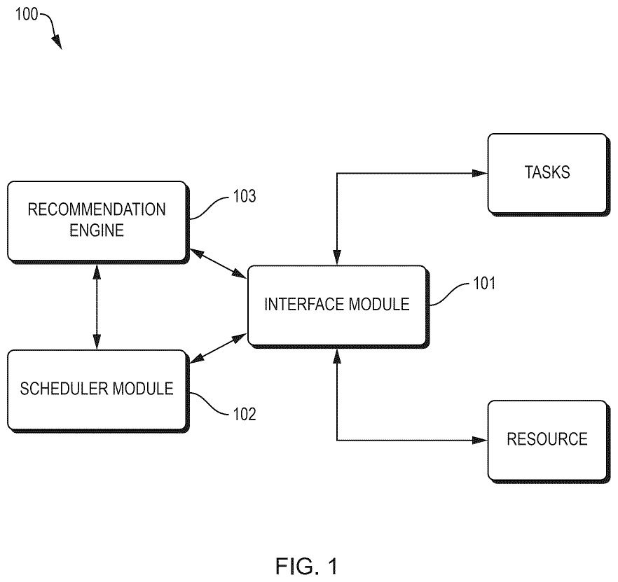

Embodiments of the present invention provide a system 100 (FIG. 1 for non-limiting example). In some embodiments, the system 100 supports workflows for scheduling tasks.

Each component of the system architecture, such as the interface module 101, scheduler module 102, and recommendation engine 103, is installed on one or more underlying computing platforms, including on-premise platforms, cloud computing platforms and/or a combination thereof, such as hybrid cloud platforms. An on-premise platform is a computing platform that may be installed and operated on the premises of an entity such as a customer of the on-premise platform. A cloud computing platform may span wide geographic locations, including countries and continents. The service and/or application components (e.g., tenant infrastructure or tenancy) of the cloud computing platform may include nodes (e.g., computing devices, processing units, or blades in a server rack) that are allocated to run one or more portions of a tenant's services and applications. When more than one service or application is being supported by the nodes, the nodes may be partitioned into virtual machines or physical machines.

As illustrated in FIG. 1, communication between the respective components of system 100 is possible using an API (Application Programming Interface) implemented to send and/or receive information between, for example, the interface module 101 and scheduler module 102. Configuration of such API's employ technology and techniques that are common or known in the art and are within the purview of one skilled in the art given the disclosure herein.

In embodiments, system 100 accepts from an entity (e.g., a target user, a team lead) a selection of one or more tasks and one or more candidate resources. In other embodiments, an entity can provide to system 100 information pertaining to one or more tasks (e.g., task description, keywords, task objectives, etc.) and information pertaining to one or more candidate resources (e.g., resource history, resource profile, previous work product of resource, etc.). As a non-limiting example, a task may be the preparation of a quarterly sales performance report, and the manager of the sales team may provide to system 100 information pertaining to the task which includes: 1) task description (e.g., overview of sales team's performance for the quarter, with key metrics such as revenue, top-performing products, regional performance, and trends), and 2) task objectives (e.g., accuracy: ensure all sales data is accurate, with no more than a 1% margin of error, target date: deliver the report to sales manager by the 25^{th} of the quarter). In some embodiments, interface module 101 is further configured to interactively receive from a user task description, keywords, or objectives of one or more tasks, or a combination thereof.

In some embodiments, the selected resource is a human resource, and the profile of the selected resource includes: employment position of the resource, years of experience, and duration of completing previous tasks similar to the selected one or more tasks based on a similarity metric and cutoff. For non-limiting example, task similarity may be determined (e.g., by scheduler module 102) based on language description similarity using natural language processing techniques (e.g., cosine similarity on TF-IDF vectors, word embeddings, semantic similarity measures that assess contextual meaning between task descriptions, etc.). In some embodiments, the cutoff is the top N most similar tasks, where N is an integer (e.g., an integer from about 3 to about 10, etc.), where the N highest-ranking tasks are considered (e.g., utilized as training data by scheduler module 102) based on similarity scores.

System 100 accepts information submitted by an entity via an interface module 101 (FIG. 1) coupled to a user interface (e.g., graphical user interface such as a webpage, mobile page, or other online screen view in a browser window, tab or the like). For example, interface module 101, which includes logic, data handling, and backend services, is connected or integrated with a graphical user interface which provides visual and interactive components.

In some embodiments, system 100 may be integrated with one or more platforms and/or user interfaces (e.g., platforms and user interfaces designed for managing teams and productivity, such as HQZen (Channel Information Technology Support and Leasing Services Corporation), etc.). In some embodiments, the user (e.g., team lead) uses a task management tool (e.g., HQZen Board) to assign tasks to candidate resources (e.g., team members). For non-limiting example, a HQZen card represents a single task and a user may assign a card to a team of members, of which, one is selected to perform the work represented by the card. The card may have a title that is written out as descriptively as possible.

In some embodiments, the interface module 101 is executable by a processor and configured to: (a) interactively receive from an entity (e.g., a user) a selection of one or more tasks; (b) interactively receive from the entity a selection of a resource from one or more candidate resources to perform the selected one or more tasks; and (c) responsively render to the entity an indication of a prediction of task completion of the selected one or more tasks by the selected resource. In some embodiments, the interface module 101 is further configured to (d): responsively render to the user an indication of the best-fit candidate resource.

Scheduler module 102 (FIG. 1) is communicatively coupled to the interface module 101. In embodiments, scheduler module 102 is configured to assess task completion and schedules tasks by predicting various aspects of task completion (e.g., how long a candidate resource takes to complete one or more tasks, how accurate the candidate resource is able to complete one or more tasks, etc.). To achieve this, an artificial intelligence (AI) model is trained on information pertaining to the candidate resource (e.g., task history of the candidate resource) and the one or more tasks. In some embodiments, scheduler module 102 is configured to compare the one or more tasks with tasks previously completed by the candidate resource and perform a similarity analysis. Scheduler module 102 is configured to use a variety of criteria for similarity analysis, training an AI model, and task completion prediction, such as but not limited to 1) task type or category (e.g., comparing tasks by their classification such as technical, administrative, etc.), 2) task complexity (e.g., matching tasks of similar difficulty or resource requirement), 3) skills and experience (e.g., checking how a candidate resource has performed on similar tasks in the past), and 4) time and accuracy (e.g., considering the time taken to complete previous tasks to determine resource suitability for the new task, how accurate was the resource able to complete the previous tasks and minimize any mistakes made, etc.). In some embodiments, scheduler module 102 is configured to compare the one or more tasks with tasks previously completed by the candidate resource and perform a similarity analysis based on task description similarity using natural language processing techniques (e.g., cosine similarity on TF-IDF vectors, word embeddings, semantic similarity measures that assess contextual meaning between task descriptions, etc.). In some embodiments, scheduler module 102 is configured to select similar tasks previously completed by the candidate resource based on a similarity score cutoff (e.g., top N most similar tasks are selected based on similarity scores, where N is an integer, e.g., an integer from about 3 to about 10, etc.).

In some embodiments, scheduler module 102 is configured to calculate a score regarding the completion of a task by a resource and responsively render this score to the entity via interface module 101. An entity (e.g., a team lead, a user) may, through interface module 101, select and define various weights for the scoring criteria. For non-limiting example, the entity may decide that the criteria consists of task completion duration and task completion accuracy, with duration weighted at 30% and accuracy (e.g., the extent of typographical errors predicted, etc.) at 70% when calculating the overall score for a resource. In this example, the higher weighting for task completion accuracy at 70% as compared to the duration of only 30% indicates that the entity prioritizes the correctness and quality of the task completion over the speed at which it is completed.

Scheduler module 102 may be configured to create, train, and execute one or more models (e.g., AI models) for evaluating information related to one or more tasks and/or one or more candidate resources. Scheduler module 102 may be divided into individual processes. Each process may be in its own software container. For example, an architect process may be configured to create, instantiate, and decide the topology of the underlying AI model, while a training process can be configured to guide and perform the training of the model. An end user may interactively or otherwise define model parameters and algorithm parameters via interface module 101. In some embodiments, a scheduler module 102 is coupled to the interface module 101 and executable by the processor, the scheduler module configured to generate, using artificial intelligence, the prediction of task completion by the selected resource based on the selected one or more tasks and profile of the selected resource. In some embodiments, the artificial intelligence comprises a language model. In some embodiments, the language model is a transformer-based language model.

Training materials for scheduler module 102 may include, but not be limited to textual description and work products from previous tasks. This can include content from previous work products, which can be provided, for example, in a human readable language, and can relate to descriptors of style, quality (e.g., extent of typographical errors), composition, or other descriptors that relate to the task. For non-limiting example, if a task relates to the preparation of a quarterly sales performance report, scheduler module 102 may be trained, using artificial intelligence models (e.g., language models), based on: style descriptors such as conciseness (e.g., the report should be free from unnecessary details, focusing only on key sales metrics and insights) and professionalism (e.g., the tone and format of the report must maintain a high level of professionalism, suitable for presentation to senior management); quality descriptors such as accuracy (e.g., all data and calculations must be precise, with no margin for error in reporting sales figures or analysis, no typographical errors) and comprehensiveness (e.g., the report must cover all relevant sales metrics, such as total revenue, sales by region, top-performing products, and trends compared to the previous quarter).

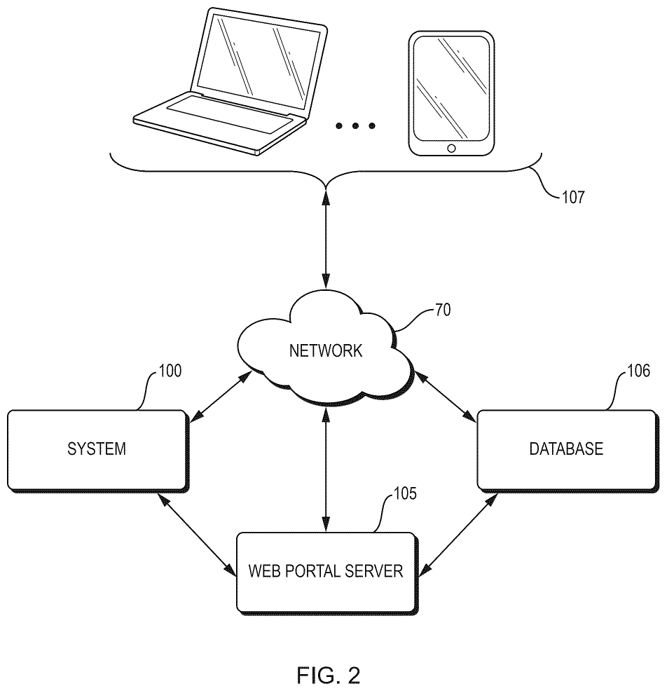

For non-limiting example, the AI model in one embodiment is a fully connected neural network that may be represented as: for i=1, . . . n, Σf(cx)ᵢ. In the first layer (i=1), the weights c are in the range (0.2-1.5) representing relative score of keywords or key phrases in the training material (e.g., textual description and work products of prior tasks). In the second layer (i=2), the weights c are in the range (0.1-0.5) representing relative score or value of certain quality attributes (e.g., professional style and tone, and conciseness); and the third layer (i=3) weights c are in the range (0.1-0.2) for relative score or value of other quality attributes (e.g., accuracy and comprehensiveness). And so forth. Other value ranges for the weights and other functions per layer are suitable. AI predictions are stored in a database 106 (FIG. 2) in association with each piece of evaluated content, allowing them to be used as inputs for another model's calculations or for communication to the system's users and other parts of the system.

In some embodiments, system 100 further comprises a recommendation engine 103 coupled to interface module 101 and/or scheduler module 102. In some embodiments, recommendation engine 103 is coupled to scheduler module 102 to receive the output indication of prediction of subject task completion from scheduler module 102. In some embodiments, recommendation engine 103 responsively determines, from a plurality of candidate resources, a best-fit candidate resource to assign one or more tasks as a function of schedule availability and task completion prediction(s). In some embodiments, recommendation engine 103 determines a best-fit candidate resource by computing, using artificial intelligence (e.g., language models), the best-fit candidate resource. In some embodiments, a best-fit candidate resource is projected to be first to be able to complete the selected one or more tasks given candidate resources schedules and historical amounts of time for task completions. In other embodiments, a best-fit candidate resource is selected based on a recommendation criteria (e.g., the top-ranked candidate resource according to a recommendation criteria). For non-limiting example, a recommendation criteria may consist of duration to and accuracy of task completion. In some embodiments, the artificial intelligence comprises a language model. In some embodiments, the language model is a transformer-based language model.

Recommendation engine 103 may be coupled to interface module 101 to responsively render to the user an indication of the best-fit candidate resource. In other embodiments, recommendation engine 103 may determine a ranking of the plurality of candidate resources, and responsively render to the user the ranking.

As a non-limiting example, suppose a task is to prepare and deliver a quarterly sales performance report by the 25th day after the end of the quarter. Recommendation engine 103 determines, from a plurality of candidate resources, a best-fit candidate resource based on a recommendation criteria which may be user-defined via interface module 101. For non-limiting example, suppose Person A is predicted, by recommendation engine 103, to complete a report in 5 hours and is estimated to have a task accuracy of 98%, based on their completion of previous similar tasks, which involved thorough analysis and minimal typographical errors. Suppose Person B is predicted, by recommendation engine 103, to complete the same report in 3 hours with an accuracy of only 50%, as their previous tasks were found to be riddled with errors and required multiple revisions. In this non-limiting example, if a user of system 100 assigns higher weightage to accuracy in the recommendation criteria, recommendation engine 103 would, via interface module 101, responsively render to the user an indication of Person A as the best-fit candidate resource and/or a ranking where Person A would be ranked first and Person B second.

In some embodiments, system 100 may be operated or accessed by users (e.g., team lead, managers, etc.). Users may access one or more components (e.g., interface module 101, scheduler module 102, recommendation engine 1031) of system 100 via a web portal server 105 (FIG. 2). For example, recommendation engine 103 is configured to determine the best-fit candidate resource or a ranking of candidate resources based on task histories of a plurality of candidate resources, while the web portal server 105 is configured to store and display the best-fit or highest-ranked candidate resource to the user. In some embodiments, users may access web portal server 105 via network 70 and one or more devices 107. Devices 107 may include any type of electronic device configured to send and receive data, such as websites and multimedia content, over network 70. For example, devices 107 may include one or more mobile devices, smartphones, personal digital assistants (“PDA”), tablet computers or any other kind of touchscreen-enabled device, a personal computer, a laptop, and/or server disposed in communication with network 70. Each of the one or more devices may, have a web browser and/or mobile browser installed for receiving and displaying electronic content received from one or more of web servers (e.g., web portal server 105). Each of the one or more devices 107 may include client devices that may have an operating system configured to execute a web or mobile browser, and any type of application. e.g., a mobile application.

Any data provided by a user or generated by one or more modules of system 100 may be stored in database 106. System 100 may use data from database 106 to improve the data collection and/or analytics of system 100 (e.g., using machine learning algorithms implemented by recommendation engine 103 on data stored in database 106). Network 70 may include the Internet, a content distribution network, or any other wired, wireless, wide area network, and/or telephonic or local network. System 100, web portal server 105, database 106, and various devices 107 may communicate with each other via network 70 using known or common network protocols.

In some embodiments, interface module 101 is a set of data processing activities that prepares instructions for presenting on display screens of one or more end-user devices 107. Interface module 101 can, for example, select and display particular tasks and candidate resources, and respond to user interaction, for example, a user selecting a specific task and/or candidate resource, and displaying relevant information about the selected task and/or candidate resource to the user.

In some embodiments, system 100 is configured to receive various user information from web portal server 105 and/or devices 107. User information may include one or more of: registration information, demographic information (e.g., age, gender, location, etc.), etc. In some embodiments, devices 107 may include a user's computer. The user may log into web portal server 105 via the computer (of devices 107) and access one or more modules of system 100. System 100 may receive some user information from a computer (e.g. user location, age, etc.) and receive other user information from the web portal server 105.

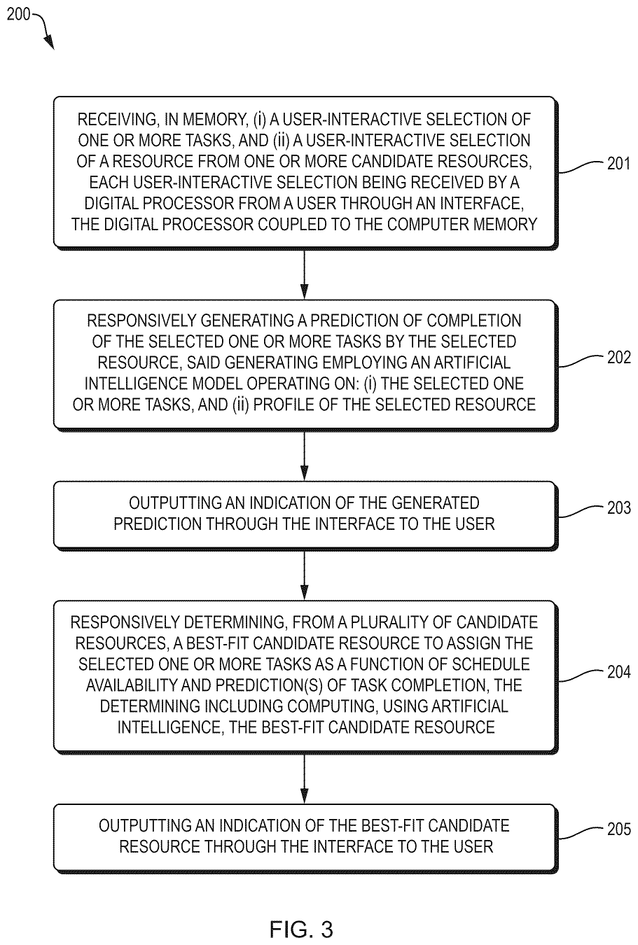

FIG. 3 is a flowchart of a method 200 of scheduling tasks, according to an embodiment. The method 200 is implemented by a digital processor and begins at step 201 by receiving, in computer memory, (i) a user-interactive selection of one or more tasks, and (ii) a user-interactive selection of a resource from one or more candidate resources. Each user-interactive selection is received by a digital processor from a user through an interface, e.g., the interface module 101. The digital processor is coupled to the computer memory. Step 202 involves responsively generating a prediction of completion of the selected one or more tasks by the selected resource. In one embodiment, said step of generating 202 employs an artificial intelligence model operating on: (i) the selected one or more tasks, and (ii) profile of the selected resource. Next, step 203 outputs an indication of the generated prediction (resulting from step 202) through the interface (e.g., interface module 101) to the user. In some embodiments, the method 200 further comprises receiving, in computer memory, (iii) a user-interactive input of task description, keywords, or objectives of one or more tasks, or a combination thereof, the user-interactive input being received by a digital processor from a user through an interface, the digital processor coupled to the computer memory.

The method 200 further includes step 204 responsively determining, from a plurality of candidate resources, a best-fit candidate resource to assign the selected one or more tasks. Step 204 determines a best-fit candidate resource as a function of schedule availability and prediction(s) of task completion, the determining including computing, using artificial intelligence, the best-fit candidate resource. Step 205 outputs an indication of the best-fit candidate resource determined by step 204, and renders the output indication through the interface (e.g., interface module 101) to the user.

The method 200 includes, and is not limited to, the computer implemented steps and stages as illustrated in FIG. 3.

### Platform Systems

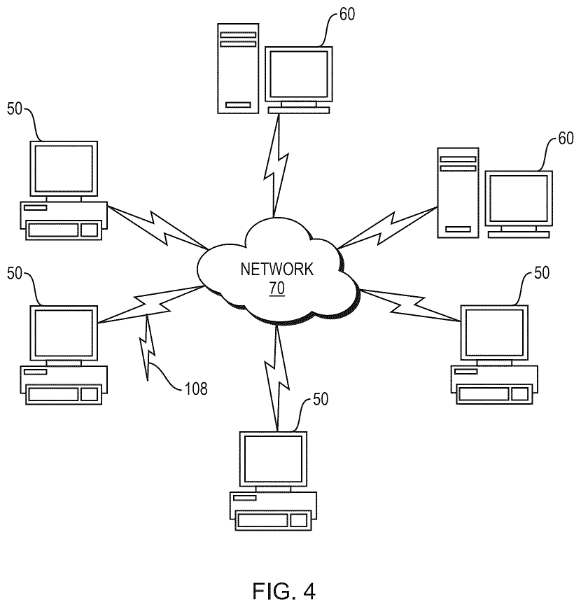

FIG. 4 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

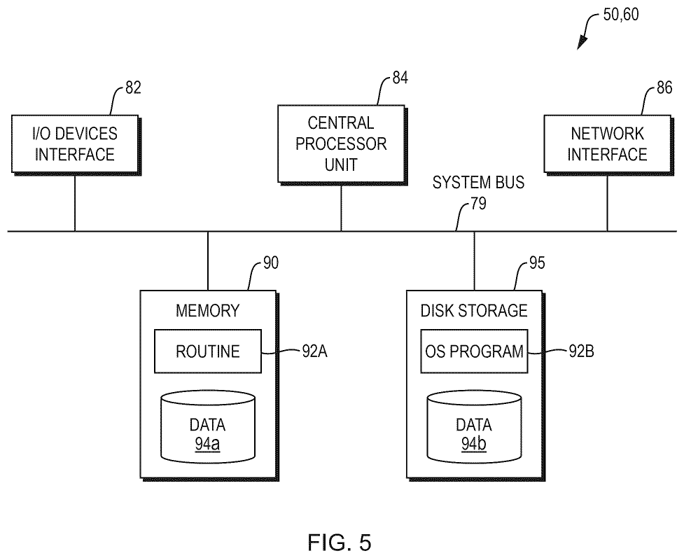

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, display monitors, printers, speakers, etc.) to the computer 50, 60. Network interface 86 allows the computer to connect to various other devices attached to a network (e.g., network 70 of FIG. 4). Memory 90 provides volatile storage for computer software instructions 92A and data 94A used to implement an embodiment of the present invention (e.g., method 200, database 106, interface module 101, scheduler module 102, and recommendation engine 103). Disk storage 95 provides non-volatile storage for computer software instructions 92B and data 94B used to implement an embodiment of the present invention. Central processor unit 84 is also attached to system bus 79 and provides for the execution of computer instructions. Client computers/devices 50 may be linked directly or through communications network 70 to other computing devices, including other client computers/devices 50 and server computers/devices 60.

In one embodiment, the processor routines 92A, B and data 94A, B are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, system 100 software instructions 92 may be implemented as a computer program propagated signal product 108 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In an embodiment disclosed herein is computer program product 92 for scheduling tasks, the computer program product 92 comprising: a non-transitory computer-readable storage medium providing at least a portion of computer code instructions that, when executed by a processor, cause an apparatus associated with the processor to: user-interactively receive a selection of one or more tasks, resulting in selected one or more tasks; user-interactively receive a selection of one resource from among one or more candidate resources, resulting in a selected resource; automatically generate a prediction of task completion of the selected one or more tasks by the selected resource, said automatically generate including employing an artificial intelligence model operating on: (i) the selected one or more tasks, and (ii) profile of the selected resource; and render as output of the apparatus an indication of the prediction of task completion by the selected resource. In some embodiments, the computer code instructions, when executed by the processor, further cause the apparatus associated with the processor to: determine, from a plurality of candidate resources, a best-fit candidate resource to assign the selected one or more tasks as a function of schedule availability and prediction of task completion, said determine including computing, using artificial intelligence, the best-fit candidate resource; and render as output of the apparatus an indication of the best-fit candidate.

In some embodiments, the computer program product 92 comprises a non-transitory computer-readable storage medium providing at least a portion of computer code instructions that, when executed by a processor, further cause the apparatus associated with the processor to: user-interactively receive task description, keywords, or objectives of one or more tasks, or a combination thereof.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so called Software as a Service (SaaS), or other installation or communication supporting end-users.

Specific details are given in the above description to provide a thorough understanding of the embodiments. However, it is understood that the embodiments may be practiced without these specific details.

The various illustrative embodiments described in connection with the disclosure herein may be implemented in hardware, software, or a combination thereof. For a hardware implementation, the embodiments may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of results of the executed function to the calling program (or program part) or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a computer-readable storage medium. A code segment or machine executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

Computer-readable medium includes both non-transitory computer storage medium and communication medium including any medium that facilitates transfer of a computer program from one place to another. A non-transitory computer-readable storage medium includes any available medium that can be accessed by a general purpose or special purpose computer. By way of example, and not limiting, non-transitory computer-readable storage medium can comprise Random Access Memory (RAM), read Only Memory (ROM), electrically Erasable Programmable Read Only Memory (EEPROM), flash memory, compact Disc (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital Subscriber Line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital Versatile Disc (DVD), floppy disk and blu-ray disc where disks usually reproduce data magnetically, while discs reproduce data optically with lasers. Combinations of the above are also included within the scope of computer-readable medium.

Other embodiments of the present invention include modifications made to the system, method, computer program product, and the like to prioritize memory usage or memory footprint goals, utilization goals for other resources such as CPUs, prediction-time goals (e.g., the elapsed time for a prediction run of the model), prediction-time variation goals (e.g., reducing the differences between model prediction times for different observation records), prediction quality goals, budget goals (e.g., the total amount that a user wishes to spend on model execution, which may be proportional to the CPU utilization of the model execution or to utilization levels of other resources), revenue/profit goals, and so on.

As used herein, the articles “a,” “an,” and “the” are used herein to refer to one or to more than one (i.e., to at least one) of the grammatical object of the article. By way of example, “an element” can mean one element or more than one element.

Also, the use of “or” means “and/or” unless stated otherwise. Similarly, “comprise,” “comprises,” “comprising” “include,” “includes,” and “including” are interchangeable and not intended to be limiting.

The disclosure generically described, will be more readily understood by reference to the following examples, which are included merely for purposes of illustration of certain aspects and embodiments of the present disclosure, and are not intended to be limiting.

### EXAMPLES

### Example 1: Embodiments of System 100 Accessed by a User on a Device

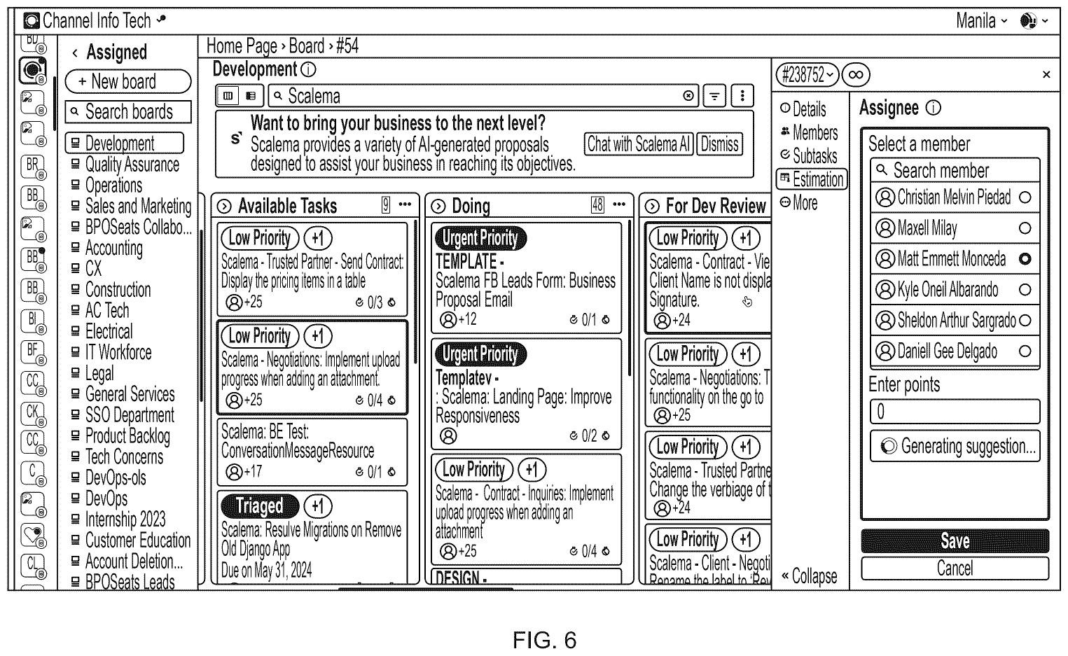

FIG. 6 shows an example of a user interface in which the task history of a selected member is being processed for predicting the duration (elapsed time or amount of time spent) to task completion, in one embodiment.

In example FIG. 6, an AI task estimation model (e.g., in scheduler module 102) is employed to predict how long an assigned candidate resource (e.g., member) will take to finish a card that they were assigned to. First, in this example, a target user opens a card that they had previously created to represent a certain task. The target user may be considered a lead on the platform, in order to assign it to members of the user's team (work or project team). As used in this example, the terms ‘user,’ ‘lead,’ ‘target user,’ and ‘lead user’ are used interchangeably. On the Estimation tab of the opened card panel, the user is able to select members of the user's team to take on the task. The AI model then pulls up (accesses or otherwise obtains) relevant data and makes a prediction.

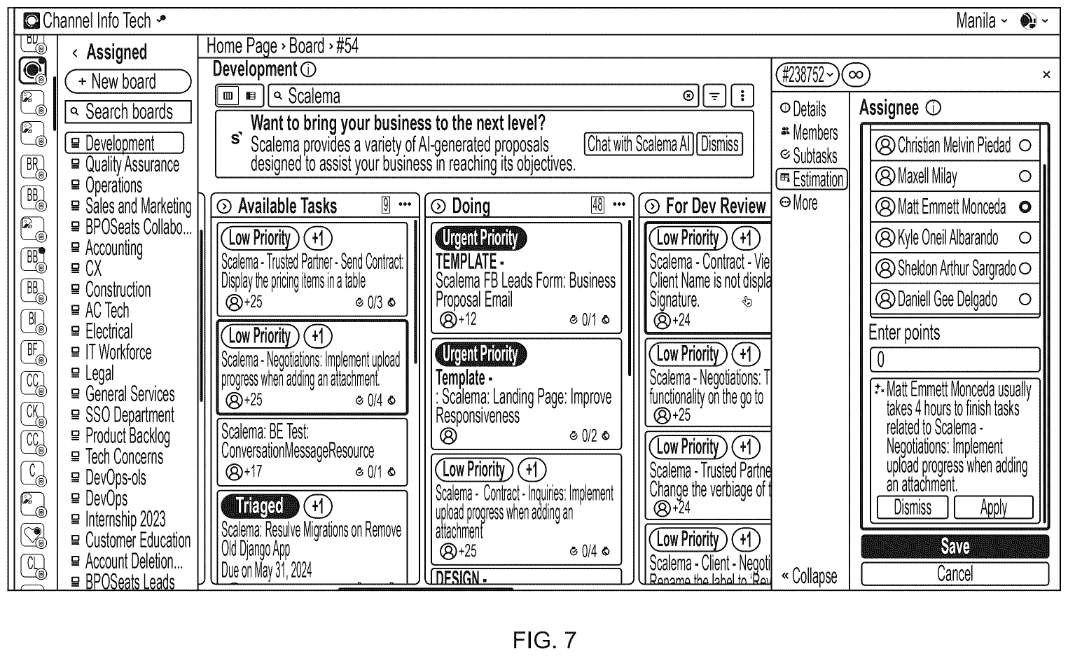

Next, the AI model (e.g., in scheduler module 102), upon selection of a member, processes the task history of the selected member and makes a prediction. This prediction is then displayed as a suggestion to the lead user (in blue), which the lead user can apply or dismiss (FIG. 7). Various libraries for scientific and technical computing, and natural language processing may be used for system 100.

### Example 2: Example of Schema of Data in Database 106

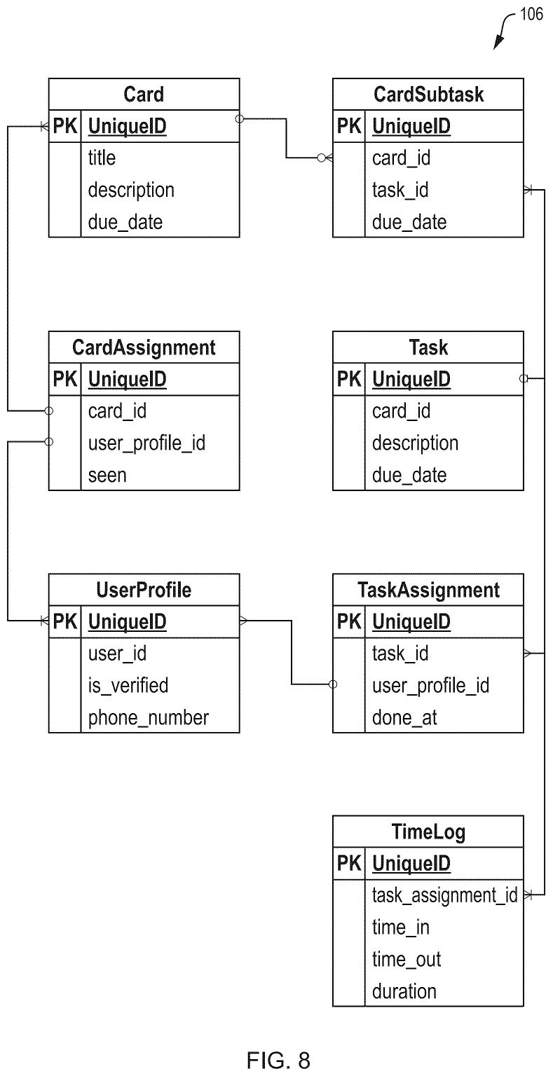

FIG. 8 is an example of a condensed schema of data in database 106 that contains information for system 100, in one embodiment. A description of example data entities and data configurations is provided next in FIG. 8 for purposes of illustration and not limitation.
1. Card—This represents a set of work items that is observable and actionable from a HQZen Kanban Board or equivalent. A card may represent just a single work item or multiple items of concern.
2. CardSubtask—An entity that connects the unit of work (Task) associated with a card. A card will always contain at least one Task.
3. Task—This unit of work connects a Kanban board (or equivalent) with the time-tracking services that measures recorded work down to the second.
4. CardAssignment—This connects the card to members on the platform who are granted access to viewing the details on the card.
5. UserProfile—An entity that connects HQZen time tracker program and/or services to many related functions on the platform.
6. TaskAssignment—This joint entity connects the assigned UserProfile to the unit of work associated with a card.
7. TimeLog—This represents a measurement of time that can be associated with tasks on a Kanban board or equivalent.

### Example 3: Example of a Method of Scheduling Tasks

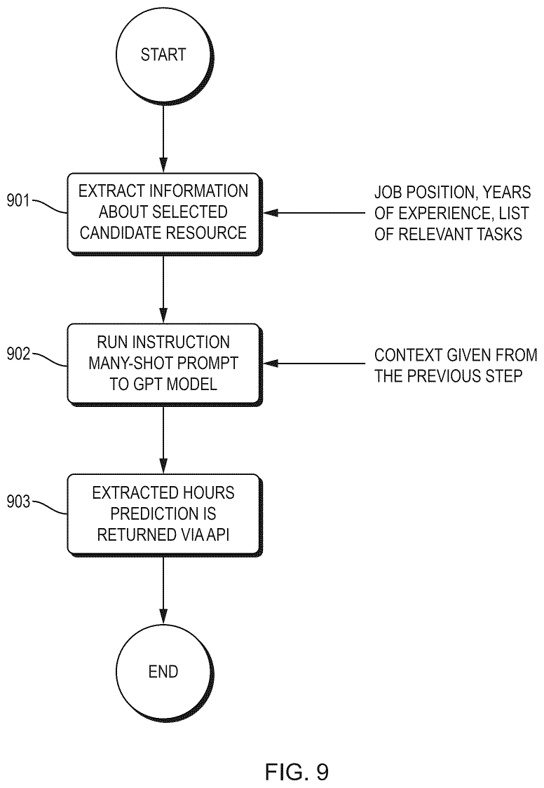

The ability to automatically generate a time estimate based on a selected candidate resource and the task under review is done on an API that is accessible from a backend setup. The API accesses a Generative Pre-trained Transformer (GPT) model with a prompt that asks for an estimate given a context packet of the task assignee's last x tasks, where x is an integer and is user-defined. This request is padded with information on the task assignee's current job position and their number of years of experience in the platform. FIG. 9 is a simplified flowchart diagram that explains an example general flow of predicting task completion. Step 901 involves a backend system (e.g., a server, data-processing component within the API) extracting information (e.g., job position, years of experience, and a list of relevant tasks) about a selected candidate resource. Next, step 902 involves the backend system running an instruction many-shot prompt to a GPT model based on the context data from step 901. At step 903, the predicted hours are returned via API.

### Example 4: Example of how the API is Defined to Generate a Time Estimate Based on a Selected Candidate Resource and a Task

For non-limiting example, presented below is pseudocode that illustrates how the API is defined (e.g., endpoint registration, request handling, data processing, response generation):

```
Import necessary modules and classes
Define class AITaskEstimationResource inheriting from BaseResource
  Define allowed methods and permissions
  Define required filter fields and constants
  Define the filter method
    Resolve and extract filters for candidate_resource_profile_pk and task_name
    Retrieve candidate resource profile and current employment
    Get job position and calculate years of experience
      If the employment has ended, calculate duration using the end date
      Else, calculate duration from the start date to the current date
    Retrieve subtasks related to the candidate resource profile
      Annotate the total duration of time logs in hours
      Filter to exclude meeting and team tasks
      Exclude fields and defer some fields for optimization
      Select related tasks for efficiency
    Create a list of similar tasks with their name and duration
    Sort the list of similar tasks based on similarity to the target task
name
    Select the top N most similar task names
    Define a helper function to find the index of an item in the list by a
field value
    Create a list of the top N similar tasks with their name and duration
    Call the function to estimate task duration using the target task name, similar
tasks, job position, and years of experience
    Return a response with the AI estimation hours
Register the resource with the appropriate endpoint and version
```

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

For example, where a web-based page is illustrated and described herein, it is understood that a mobile page, or other online screen view or equivalent is suitable and within the purview of one skilled in the art given the principles of the present disclosure.

1. A computer-based system for scheduling tasks, comprising:
(1) an interface module executable by a processor and configured to:
(a) interactively receive from a user a selection of one or more tasks;
(b) interactively receive from the user a selection of a resource from one or more candidate resources to perform the selected one or more tasks; and
(c) responsively render to the user an indication of a prediction of task completion of the selected one or more tasks by the selected resource,
(2) a scheduler module communicatively coupled to the interface module and executable by the processor, the scheduler module configured to generate, using artificial intelligence, the prediction of task completion by the selected resource based on the selected one or more tasks and profile of the selected resource.

2. The system of claim 1, wherein the task completion includes time duration for the resource to complete the selected one or more tasks.

3. The system of claim 1, wherein the artificial intelligence comprises a language model.

4. The system of claim 3, wherein the language model is a transformer-based language model.

5. The system of claim 1, wherein the selected resource is a human resource, and the profile of the selected resource includes: employment position of the resource, years of experience, and duration of completing previous tasks similar to the selected one or more tasks based on a similarity metric and cutoff.

6. The system of claim 1, wherein the interface module is further configured to interactively receive from a user task description, keywords, or objectives of one or more tasks, or a combination thereof.

7. The system of claim 1, further comprising: (3) a recommendation engine coupled to receive the output indication of prediction and responsively determine, from a plurality of candidate resources, a best-fit candidate resource to assign the selected one or more tasks as a function of schedule availability and prediction of task completion, the determining including computing, using artificial intelligence, the best-fit candidate resource, and wherein the interface module is further configured to: (d) responsively render to the user an indication of the best-fit candidate resource.

8. A computer-based method of scheduling tasks, comprising:
receiving, in computer memory, (i) a user-interactive selection of one or more tasks, and (ii) a user-interactive selection of a resource from one or more candidate resources, each user-interactive selection being received by a digital processor from a user through an interface, the digital processor coupled to the computer memory;
responsively generating a prediction of completion of the selected one or more tasks by the selected resource, said generating employing an artificial intelligence model operating on: (i) the selected one or more tasks, and (ii) profile of the selected resource; and
outputting an indication of the generated prediction through the interface to the user.

9. The method of claim 8, wherein the task completion includes time duration for the resource to complete the selected one or more tasks.

10. The method of claim 8, wherein the artificial intelligence comprises a language model.

11. The method of claim 10, wherein the language model is a transformer-based language model.

12. The method of claim 8, wherein the selected resource is a human resource, and the profile of the selected resource includes: employment position of the resource, years of experience, and duration of completing previous tasks similar to the selected one or more tasks based on a similarity metric and cutoff.

13. The method of claim 8, further comprising: responsively determining, from a plurality of candidate resources, a best-fit candidate resource to assign the selected one or more tasks as a function of schedule availability and prediction of task completion, the determining including computing, using artificial intelligence, the best-fit candidate resource; and outputting an indication of the best-fit candidate resource through the interface to the user.

14. A computer program product for scheduling tasks, the computer program product comprising: a non-transitory computer-readable storage medium providing at least a portion of computer code instructions that, when executed by a processor, cause an apparatus associated with the processor to:
user-interactively receive a selection of one or more tasks, resulting in selected one or more tasks;
user-interactively receive a selection of one resource from among one or more candidate resources, resulting in a selected resource;
automatically generate a prediction of task completion of the selected one or more tasks by the selected resource, said automatically generate including employing an artificial intelligence model operating on: (i) the selected one or more tasks, and (ii) profile of the selected resource; and
render as output of the apparatus an indication of the prediction of task completion by the selected resource.

15. The computer program product of claim 14, wherein the task completion includes time duration for the resource to complete the selected one or more tasks.

16. The computer program product of claim 14, wherein the artificial intelligence comprises a language model.

17. The computer program product of claim 16, wherein the language model is a transformer-based language model.

18. The computer program product claim 14, wherein the selected resource is a human resource, and the profile of the selected resource includes: employment position of the resource, years of experience, and duration of completing previous tasks similar to the selected one or more tasks based on a similarity metric and cutoff.

19. The computer program product of claim 14, wherein the computer code instructions, when executed by the processor, further cause the apparatus associated with the processor to: user-interactively receive task description, keywords, or objectives of one or more tasks, or a combination thereof.

20. The computer program product of claim 14, wherein the computer code instructions, when executed by the processor, further cause the apparatus associated with the processor to: determine, from a plurality of candidate resources, a best-fit candidate resource to assign the selected one or more tasks as a function of schedule availability and prediction of task completion, said determine including computing, using artificial intelligence, the best-fit candidate resource; and render as output of the apparatus an indication of the best-fit candidate.
